(19) United States
(12) Patent Application Publication
(10) Pub. No.: US 2007/0289101 A1
(43) Pub. Date: Dec. 20, 2007

(54) Method and Apparatus for No-Touch Door Opener

(76) Inventors: Kim Casteel, (US); Scott Casteel, (US)

Correspondence Address: SCOTT CASTEEL, 1473 S.W. SAN SEBASTIAN AVE., PORT ST. LUCIE, FL, 34953, US

(21) Appl. No.: 11/425,093

(22) Filed: Jun. 19, 2006

(51) Int. Cl. B25G 3/32

(52) U.S. Cl. 16/422

(57) ABSTRACT

This invention is a method and apparatus by which potentially germ and virus infected doors can be safely and affectively opened without the user physically touching the potentially contaminated surface. The invention affectively hooks or grasps the preexisting door handle and allows the user to pull the door open. This invention also can be used to push doors open without physically touching potentially germ infected surfaces as well.

### CROSS-REFERENCE TO RELATED APPLICATIONS

Not Applicable

### BACKGROUND OF THE INVENTION

One of the leading causes of the spread of cold, flu and disease is through direct contact with these pathogens by touching public surfaces like door handles, banisters and then touching ones eyes or nose. This invention in method as well as apparatus allows it's user to avoid these potentially dangerous contacts by using a tool by which most public doors can be opened without physically touching the contaminated surface. This invention can be utilized to minimize further contamination and spread of these pathogens. This invention does not require modification or installation of any special hardware on the door in order for it to function.

### BRIEF SUMMARY OF THE INVENTION

This invention is a method and apparatus by which potentially germ and virus infected doors can be safely and affectively opened without the user physically touching the potentially contaminated surface. The invention affectively hooks or grasps the preexisting door handle and allows the user to pull the door open. This invention also can be used to push doors open without physically touching potentially germ infected surfaces as well.

### BRIEF DESCRIPTION OF THE DRAWINGS

FIG. 1—Side view of invention.

FIG. 2—Front view of invention.

FIG. 3—Top view of invention.

FIG. 4—View of invention opening one version of a public door handle.

FIG. 5—View of invention in a user's hand.

FIG. 6—View invention opening one version of a public door handle.

FIG. 7—View invention opening one version of a public door handle.

FIG. 8—View invention opening one version of a public door handle.

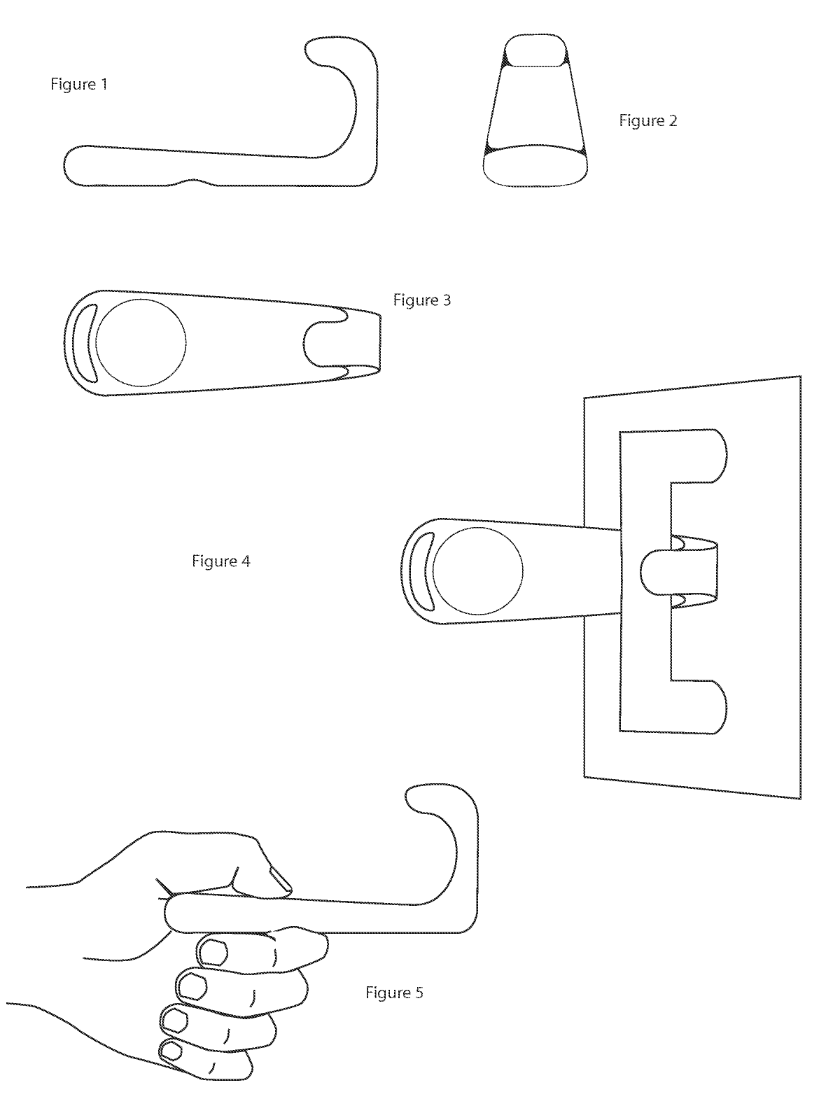

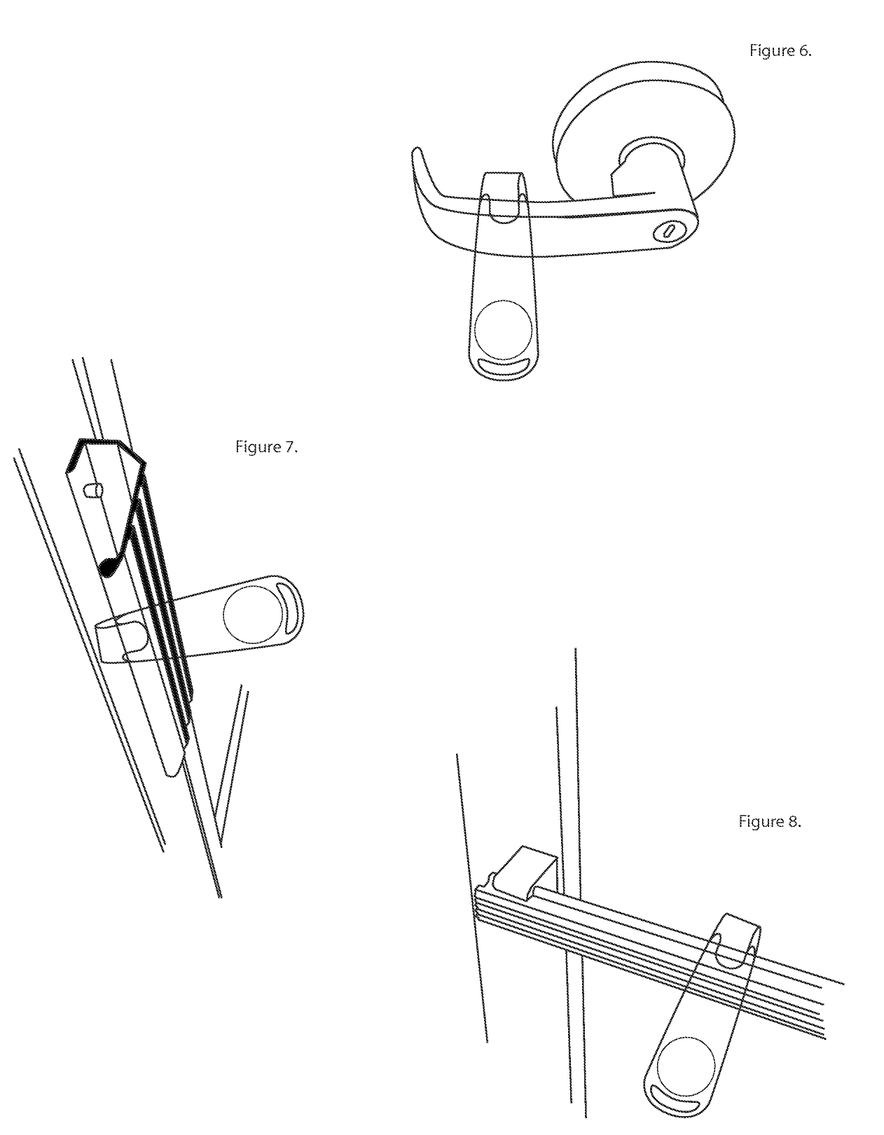

### DESCRIPTION OF THE PREFERRED EMBODIMENT

This invention relates to hand cleanliness as it relates to opening doors which may have germs, virus and other contaminants on those surfaces which are normally opened by touching them with your bare hand.

This apparatus and method have been specifically designed to pull and push open most public doors found in stores, public parks, offices, public bathrooms etcetera.

It is important to note that this invention does not require any modification or hardware additions or installations to the door. The grasping device is designed to open said doors in their current state of design thus avoiding contamination of the user's hands.

The invention is simply designed from one piece of material. This material could be wood, metal or plastic as long as it exhibits enough strength to pull open a door. Another aspect of the invention surface is that it could be coated with germ resistant coatings and polymers so as to not pickup or carry along the germs that it comes in contact with. An example of (But Not Limited to) this surface is from AgION® Antimicrobial Technologies. This compound is designed to serve as a major line of defense in combating microorganisms. AgION® antimicrobials have proven to be very effective in controlling bacteria, mold and mildew.

### AgION Technologies, Inc.

### 60 Audubon Road

### Wakefield, Mass. 01880

### Tel: +1-781-224-7100

### Fax: +1-781 246 3314

### E-mail: sales@agion-tech.com

The manufacturing process for this invention could include injection molding or CNC machining.

The design and use of this invention is such that it can be easily added to an existing key chain for easy access in times of need. It could also easily fit in a purse or on a lanyard or tether. When approaching a door that the user does not desire to touch, the user would simply remove the tool from the pocket or purse and pull or push the door open thus minimizing any unwanted contact with the potentially contaminated surface.

What is claimed is:

1. Apparatus for No-Touch door opener including:
(a) A handheld tool that grasps or hooks the door handles for no-touch opening be it pulling or pushing said door.

2. Method for No-Touch door opener including:
(a) A handheld tool that grasps or hooks the door handles for no-touch opening be it pulling or pushing said door.
